(19) United States
(12) Patent Application Publication
(10) Pub. No.: US 2009/0037218 A1
(43) Pub. Date: Feb. 5, 2009

(54) METHOD OF OPERATING A HEALTHCARE FACILITY

(76) Inventor: Afser Shariff, Toledo, OH (US)

Correspondence Address: FRASER CLEMENS MARTIN & MILLER LLC, 28366 KENSINGTON LANE, PERRYSBURG, OH, 43551, US

(21) Appl. No.: 12/184,579

(22) Filed: Aug. 1, 2008

Related U.S. Application Data
(60) Provisional application No. 60/953,788, filed on Aug. 3, 2007.

(51) Int. Cl. G06Q 50/00; G06Q 30/00; G06Q 10/00

(52) U.S. Cl. 705/2

(57) ABSTRACT

A method of operating a healthcare facility includes off-site staff members employed by a service provider. The staff members are in virtual communication with the healthcare facility.

### FIELD OF THE INVENTION

This application claims the benefit of U.S. Provisional Patent Application Ser. No. 60/953,788 filed on Aug. 3, 2007 hereby incorporated herein by reference.

### FIELD OF THE INVENTION

The present invention relates to a method of operating a healthcare facility, and more particularly, a method of operating a healthcare facility with off-site staff members working in a virtual facility in communication with the healthcare facility is disclosed.

### BACKGROUND OF THE INVENTION

In a typical healthcare facility, a large portion of the overhead costs of operating the facility is related to data entry services. Data entry is usually performed by a facility staff member such as a secretary, a medical assistant, or a nurse. To decrease the data entry labor burden on the staff member, to improve the quality and accuracy of the data entered into a patient record, and to improve the quality of care delivered to the patient by the facility staff member, electronic medical records (EMR) have been developed. EMRs were developed using algorithms designed to decrease the number of employees conducting data entry within a medical facility. However, in practice EMRs have increased the number of staff members employed by a facility due to the complexity of the software and the number of data fields required to be populated in the EMR.

An additional problem associated with the development and introduction of EMRs and other practice management modules into healthcare facilities is an increase in the training time of newly hired staff members. As a new staff member is hired by the healthcare facility, trained staff members are burdened with an additional task of training the new staff member, thereby preventing the completion of typical daily tasks. Prospective staff members are typically not trained in healthcare facility methods of operation prior to employment. If the prospective staff member has been trained, the training is general in nature and not specialized to particular software programs and healthcare specialties. Furthermore, because data entry positions are usually entry level positions, staff turnover is frequent.

The complexity in operating a healthcare facility precludes hiring temporary staff members if a permanent staff member is sick, disabled, on vacation, or otherwise indisposed. To avoid the detrimental effects associated with an absent staff member, most healthcare facilities hire extra staff members. In the event that the healthcare facility expands or if an additional facility is opened, new staff members must be hired and trained. Current healthcare facilities are not adapted to readily downscale or upscale its work force as necessary based on market conditions, employer vacationing, and other unforeseeable office closures.

Because of the time and costs associated with data entry, many healthcare facilities have contracted the data entry to offshore businesses. The data entry typically contracted out relates to coding, billing, and transcription. Offshore transcription services have raised numerous problems regarding the confidentiality of patient records, language barrier issues, and the differences in time zones from country to country. Physicians have resorted to combining their own notes, dictated notes, electronic medical records, and audiovisual records of patient encounters to facilitate accurate and complete records for transcription. However, the combination of various notes and records and the transmittal of notes and records offshore results in a significant cost and a time delay.

During a visit of a typical healthcare facility, the physician will examine a patient while writing notes related to the patient's concerns, injuries, and symptoms. To facilitate the examination of as many patients as possible, the physician's notes are typically written in shorthand. At the end of the day, or whenever the physician has the time, the notes are expounded upon by the physician. However, because many hours may have passed between the patient examination and the physician review of the records, some details of the examination may be lost. Further, by taking notes during the examination, the physician is spending less time speaking or listening to the patient.

In some healthcare facilities, a nurse or other staff member will accompany the physician during the examination to take notes. The nurse will later expound on the notes to complete the record of the examination and possibly enter the record of the examination into an EMR. Next, the nurse gives the patient record to the physician for review and approval. To reduce the amount of time required by the nurse to generate the EMR, some healthcare facilities provide computers in every examination room. The cost for a healthcare facility to staff a sufficient number of nurses and staff members to take notes for physicians during patient examinations, as well as the cost to provide computers in every examination room, is substantial. Increased costs to the healthcare facility result in increased cost for patient care.

Further, typically staff members are not specialized in a particular area due to the risk associated with specialization. Outside of large urban areas, most cities have a limited number of specialists. If a staff member quits or is terminated from the healthcare facility, the job prospects of the staff member with specialized training would be limited.

It would be desirable to develop a method of accelerating the workflow and increasing the productivity of a healthcare facility staff while minimizing cost.

### SUMMARY OF THE INVENTION

Concordant and congruous with the present invention, a method of accelerating the workflow and increasing the productivity of a healthcare facility staff while minimizing cost has surprisingly been discovered.

In one embodiment, a method of operating a healthcare facility includes the steps of providing a service provider employing a plurality of staff members; providing a healthcare facility; training each of the staff members in at least one of software, hardware, terminology, and practices of the healthcare facility in at least one of a classroom setting, a practical setting, virtual training, and on-site training at a facility of the service provider; and providing communication between the staff members and the healthcare facility to facilitate off-site support of the healthcare facility by the staff members.

In another embodiment, a method of operating a healthcare facility includes the steps of providing a service provider employing a plurality of staff members; providing a healthcare facility; training each of the staff members in at least one of software, hardware, terminology, and practices of the client service facility in at least one of a classroom setting, a practical setting, virtual training and on-site training at a facility of the service provider; training additional staff members in the software, hardware, terminology, and practices of the healthcare facility by a previously-trained one of the staff members; and providing communication between the staff members and the healthcare facility to facilitate off-site support of the healthcare facility by the staff members.

In another embodiment, a method of operating a client service organization includes the steps of providing a service provider employing a plurality of staff members; providing a service organization facility; training the staff members in at least one of software, hardware, terminology, and practices of the client service facility in at least one of a classroom setting, a practical setting, virtual training, and on-site training at the service organization facility; and providing communication between the staff members and the service organization facility to facilitate off-site support of the service organization facility by the staff members.

### BRIEF DESCRIPTION OF THE DRAWINGS

Other objects and advantages of the invention will become readily apparent to those skilled in the art from reading the following description of the invention when considered in the light of the accompanying drawings, in which:

FIG. 1 is a schematic block diagram of a model of operating a plurality of healthcare facilities using the methods according to an embodiment of the invention;

FIG. 2 is a schematic block diagram of a model of operating a plurality of healthcare facilities using the methods according to another embodiment of the invention; and

FIG. 3 is a schematic block diagram of a model of operating a plurality of healthcare facilities using the methods according to another embodiment of the invention.

It is to be understood that the present invention is not limited in its application to the details disclosed herein, since the invention is capable of other embodiments, and of being practiced or carried out in various ways within the scope of the appended claims. Also, it is to be understood that the phraseology and terminology employed herein is for the purpose of description, and not of limitation.

### DETAILED DESCRIPTION OF THE PREFERRED EMBODIMENT

The following detailed description and appended drawings describe and illustrate various exemplary embodiments of the invention. The description and drawings serve to enable one skilled in the art to use the invention, and are not intended to limit the scope of the invention in any manner. In respect of the methods disclosed, the steps presented are exemplary in nature, and thus, the order of the steps is not necessary or critical.

A method of accelerating the workflow and increasing the productivity of a healthcare facility is initiated by a primary service provider employing prospective staff members for the healthcare facility. The contemplated healthcare facility typically is a private healthcare practice, a hospital, a public healthcare clinic, and the like, for example. It is also understood that the methods similar to those described herein may be adapted for use by service organizations other than those involved in healthcare such as, for example firms engaging accounting, law, architecture, or any other client service facility adapted to provide service on a client-by-client basis. The staff members may include data entry personnel, secretarial assistants, medical assistants, nurses, or physicians, as desired. The staff members are typically trained to use the methods, equipment, software, and other technology of the service provider. However, the staff members may also be trained to use the methods, equipment, software, and other technology of a particular healthcare facility or specialized practice area.

Next, the staff members are assigned to the healthcare facility to develop a relationship with on-site employees of the healthcare facility. During the period of time the staff members are working at the healthcare facility, the staff member will observe the workflow and dynamics of the office; shadow the on-site employees to learn standard facility practices; and observe the styles, preferences, and habits of the physicians of the facility. The assigned staff members will also observe the use of the hardware and software adopted by the healthcare facility. The staff members will then be trained to use the hardware and software. The staff members may be trained by the on-site employees of the healthcare facility, by the service provider, or by the manufacturer of the hardware and software.

The staff members will then generate template form documents for the routines and practices observed in the healthcare facility. Such template forms may include patient visit charts, billing statements and letters, appointment notices and reminders, referral letters, and the like. The staff members will then return to the service provider to train other staff members to follow the protocols of the healthcare facility. All trained staff members of the service provider assigned to work with a particular healthcare facility will then be trained in the specialties of the particular healthcare facility. For example, the staff members may be trained in the terminology and typical procedures of an ear, nose, and throat (ENT) facility to recognize whether a particular test or lab should be performed during a healthcare facility visit; whether the physician should request additional information from a patient; if a diagnosis was not made; and the like.

A staff member may be trained in the specialties of numerous types of healthcare facilities, which may require additional or new training by the service provider from time to time. Alternatively, staff members may be trained in a specific specialty or trained based on the operation of a particular healthcare facility by the service provider prior to working with or being sent to a healthcare facility for the first time. The training of the staff members may occur in a classroom-like setting, in a practical setting, by virtual training, by on-site training, or a combination thereof. The service provider may compile a curriculum based on the protocols and preferences of a particular healthcare facility or specialty. Additionally, the staff members may be trained by other staff members familiar with the practices, protocols, terminology, and the like of a particular healthcare facility or specialty. The service provider may then train staff members in the preferences, software, hardware, daily operations, terminology, and procedures of a particular healthcare facility or specialty prior to the staff member's first visit to the healthcare facility. It is understood that the staff member may be trained to service a plurality of healthcare facilities with different specialties.

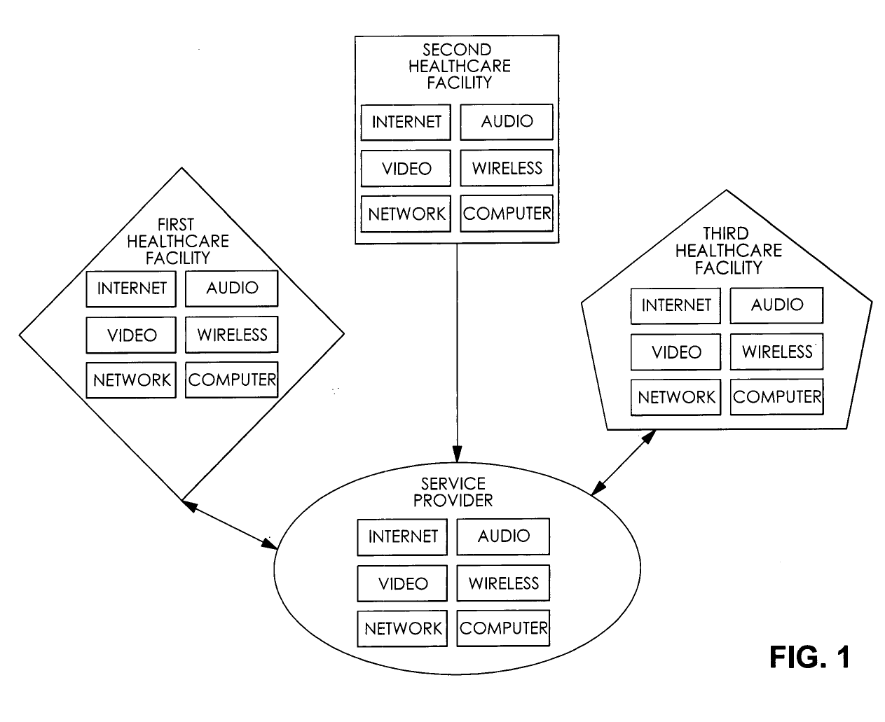

The hardware and software configurations of the healthcare facility are established at an off-site facility by the service provider for use by the staff member. The off-site facility may be equipped with a telephone, a computer, an internet connection, a wireless internet connection, a network connection, a video camera, a monitor, a modem, internet radio transmission and reception equipment, a VOIP connection, instant messaging means, and the appropriate security measures therefor. The off-site facility may be a building or facility of the service provider that houses all of the staff members and communication between the staff members and the healthcare facilities, as illustrated in FIG. 1, or the off-site facility may be the home of a staff member. The off-site facility may be in the same city as the healthcare facility; or the off-site facility may be located in another state or country. Providing an off-shore facility may minimize the overhead and training costs of the staff members by the service provider. By providing and training a plurality of staff members, the service provider provides a surplus of staff members trained to complete the work of the healthcare facility regardless of absenteeism due to illness, vacation, and the like.

The healthcare facility is equipped with hardware and software for communication with the off-site facility and the staff members. Computers, secured computer networks, audio and video equipment in examination rooms, and computers and audio and video equipment in operating rooms are typically included. The networks are adapted to facilitate communication between the staff members and the healthcare facility and EMRs. The audio and video equipment may include microphones, speakers, cameras, display monitors, internet radio transmission and reception equipment, telephones, VOIP, instant messaging means, and the like to facilitate live audio and visual communication between the physicians and staff members. Audio and video files of physician and patient and/or nurse and patient interactions are stored on the secured network for a desired time and then deleted to maintain client confidentiality. It is understood that the healthcare facility may use only audio equipment, as desired. The communication means facilitate the virtual presence at the site of the healthcare facility from off-site employees.

Interactive computers in the patient examination rooms may generate a cartoon character or other simulation adapted to entertain and/or engage the patient. The simulation typically reflects the personal traits of the patient such as the patient's ethnicity, age, interests, gender, or the like. The simulation may also be controlled by a staff member in order to interact with the patient to obtain information necessary for the physician's examination or processing of healthcare facility paperwork.

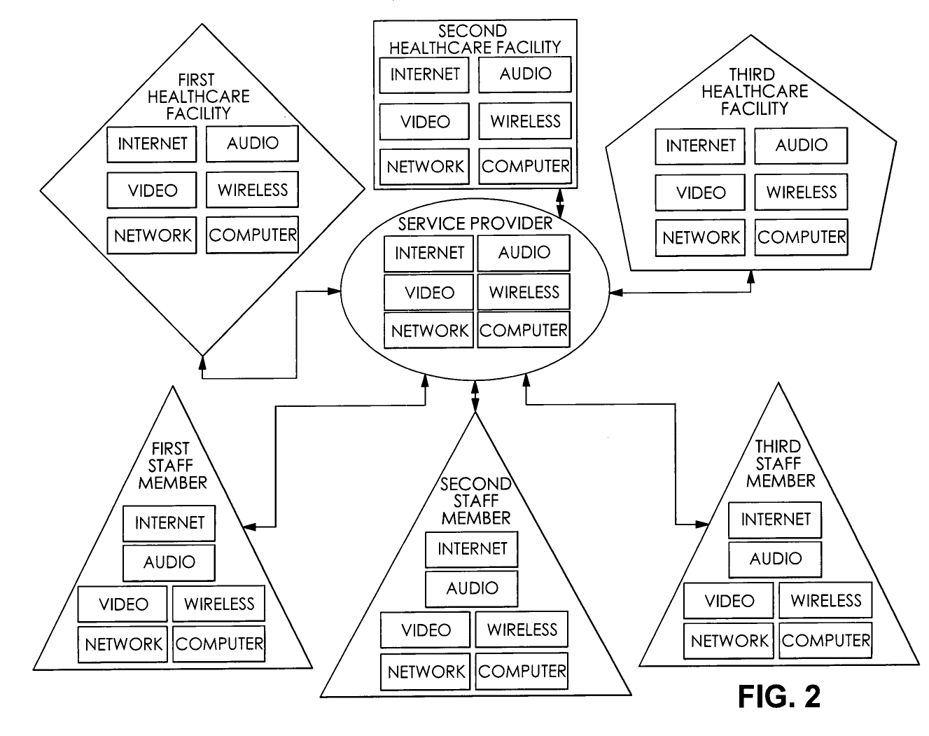

FIG. 2 illustrates a schematic block diagram of a plurality of healthcare facilities in communication using a variety of means for communication with a plurality of staff members employed by the service provider. As shown, a first healthcare facility contracted with the service provider receives the support services of any of a first staff member, a second staff member, and a third staff member. A second healthcare facility contracted with the service provider receives the support services of any of a first staff member, a second staff member, and a third staff member. A third healthcare facility contracted with the service provider receives the support services of any of a first staff member, a second staff member, and a third staff member. Each of the staff members is equipped with communication means to communicate with the communication means of the respective healthcare facilities. The communication means include, but are not limited to, audio and video equipment, computer networking, wireless internet, and computers. It is understood that the staff members may communicate with the healthcare facilities by the communication means independently of the service provider or the staff members may communicate with the healthcare facilities by the communications through communication channels at and through the service provider.

The staff members may perform any desired task for the healthcare facility. For example, the staff member may contact the patient in advance of a healthcare facility visit to record demographic information, verify insurance referrals, obtain test information, and the like. The staff member may also contact the patient to obtain family history data, medical history data, surgical history data, or to obtain details regarding the purpose of the immediate healthcare facility visit. Additionally, a checklist of information and questions may be provided to the patient by the staff member for completion prior to the office visit. Once the patient is in the examination room, the staff member may monitor the office visit over the internet or other audiovisual connection to record the details of the office visit while the physician interacts with the patient. The physician will speak aloud with the patient and relay information and directions to the staff member for recordation. By utilizing the staff member to record the office visit data, the physician is free to give more personal attention and care to the patient. The examination and data received therefrom may be recorded by the audiovisual equipment and saved for later review by the staff member, an on-site employee, or the examining physician. The staff member will then record the details of the office visit for each particular patient into the EMR system to generate a full record of the office visit. In the event the patient was referred to the physician, the staff member will generate and send a letter to the referring physician for the referring physician's records.

After the patient has met with the physician, and before the patient leaves the healthcare facility, the staff member will schedule a follow up visit, laboratory tests, prepare referral documents to another physician, and schedule surgical procedures, as necessary. A bill for the office visit including ICD-9 and CPT codes, and the like is then prepared. The office visit record, scheduling information, referral information, billing information, and any other record or information prepared by the staff member is then sent to the physician for review and approval. After a desired amount of time, the office visit recording may be destroyed. If the staff member is a doctor or nurse, the staff member may contact patients for follow up advice, follow up care, or to diagnose or treat patients over the phone. After the physician has reviewed and approved the records and information, back office functions such as coding, billing, and collections are performed by the staff members, thereby freeing up physicians and nurses to treat patients.

If the healthcare facility is a hospital, the staff members are trained and function as described herein. Additionally, the staff member may monitor and communicate with physicians in an operating room during a surgical procedure via audiovisual equipment. During the procedure the staff member may record and process operating room charge information, time data, and other required data. The steps taken by the physician, anesthesiologist, nurse, and other members of a surgical team are spoken aloud, similar to teaching a resident or medical student, for recordation by the staff member. An operative report is transcribed, printed, and sent to the physician or surgeon, and the operative report may be reviewed and approved while the patient is in recovery. Because of the staff member, the circulator typically in the operating room during an operation may monitor and cover a plurality of surgeries at one time. In the event one operating room requires a particular piece of equipment while the circulator is in a different operating room, the staff member may notify the circulator accordingly. Should an operating room crisis occur, upon the order of a member of the surgical team, the staff member may request additional equipment, surgeons, or consultations for the patient without any member of the surgical team leaving the patient. Back office functions such as coding, billing, and collections are performed by the staff members, thereby freeing up physicians and nurses to treat patients.

Because the staff members are in communication with the healthcare facility, less space is required at the healthcare facility. Communication between the staff members and the healthcare facility allows flexibility in staff member scheduling. Further, since the off-site facility may be the home of a staff member, the staff member may choose to continue to work for the service provider and start a family instead of quitting a job to pursue a family. Also, the service provider may employ a great number of trained staff members, thereby alleviating healthcare facility issues caused by staff turnover, staff absence, slow business times, and busy business times. If the staff member is off-shore, the cost to employ the off-site staff member may be less than the cost to employ the on-site staff member.

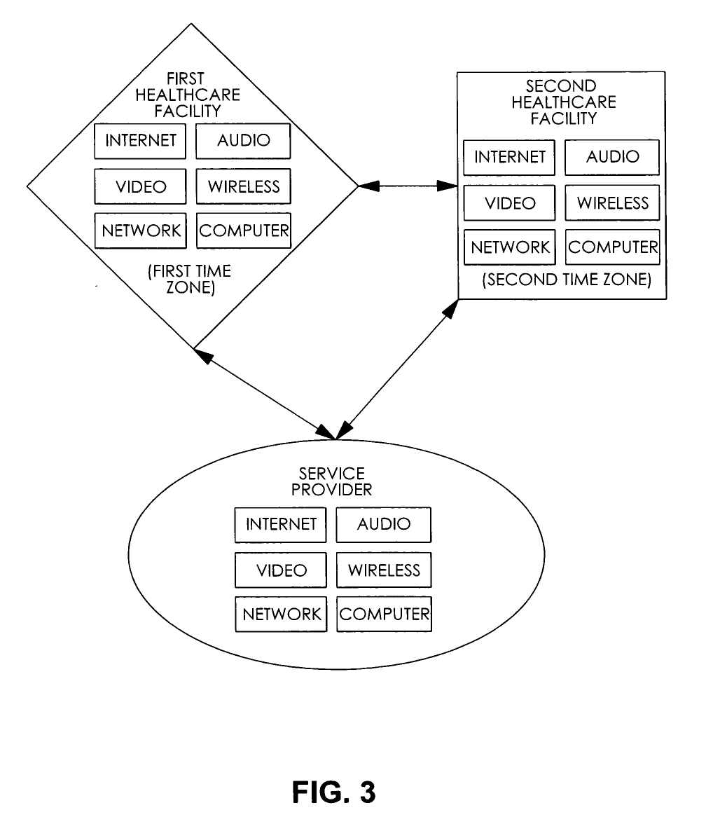

Additionally, multiple healthcare facilities in different time zones may agree to share staff members so that the healthcare facilities are efficiently and appropriately staffed with the staff members during high work times and low work times, as schematically illustrated in FIG. 3. It is understood that healthcare facilities sharing staff members may be in the same time zone. Healthcare facilities may choose to share staff members because one healthcare facility is temporarily overstaffed while another healthcare facility is temporarily understaffed without having to fire or cease a relationship with a staff member. As shown, a first healthcare facility in a first time zone in communication with a second healthcare facility in a second time zone, and both the first and the second healthcare facilities are in communication with the service provider. Because of the difference in time zones between the first healthcare facility and the second healthcare facility, a staff member provided by the service provider may communicate with and support the first healthcare facility for a portion of a work day and communicate with and support the second healthcare facility for another portion of a work day. Also because of time zone differences, the staff member may communicate with and support both healthcare facilities at the same time due to different high work times and low work times of the healthcare facilities. Additionally, if the first healthcare facility has on-site staff member, the staff member may communicate with the second healthcare facility from the first healthcare facility and achieve the same staff member sharing objective.

In accordance with the provisions of the patent statutes, the present invention has been described in what is considered to represent its preferred embodiment. However, it should be understood that the invention can be practiced otherwise than as specifically illustrated and described without departing from its spirit or scope.

What is claimed is:

1. A method of operating a healthcare facility including the steps of:
providing a service provider employing a plurality of staff members;
providing a healthcare facility;
training each of the staff members in at least one of software, hardware, terminology, and practices of the healthcare facility in at least one of a classroom setting, a practical setting, virtual training and on-site training at a facility of the service provider; and
providing communication between the staff members and the healthcare facility to facilitate off-site support of the healthcare facility by the staff members.

2. The method of operating healthcare facility of claim 1, further including the step of training additional staff members in the software, hardware, terminology, and practices of the healthcare facility by at least one of the previously-trained staff members.

3. The method of operating a healthcare facility of claim 1, wherein the staff members generate template forms for the healthcare facility in view of the healthcare facility training.

4. The method of operating a healthcare facility of claim 1, wherein the staff members are trained in a plurality of specialties.

5. The method of operating a healthcare facility of claim 1, wherein the staff members are trained in a particular specialty.

6. The method of operating a healthcare facility of claim 1, wherein the staff members include at least one of a data entry employee, a secretarial assistant, a medical assistant, a nurse, and a physician.

7. The method of operating a healthcare facility of claim 1, wherein the communication between the staff members and the healthcare facility is provided from one of a facility of the service provider and a facility of at least one of the staff members.

8. The method of operating a healthcare facility of claim 1, wherein the staff members and the healthcare facility communicate virtually through at least one of a telephone, a computer, an internet connection, a wireless internet connection, a network connection, a video camera, a monitor, a modem, an internet radio transmission and reception equipment, a VOIP connection, and instant messaging means.

9. The method of operating a healthcare facility of claim 8, wherein the communication occurs during a patient visit to the healthcare facility.

10. The method of operating a healthcare facility of claim 9, wherein at least one of the staff members is responsible for one of contacting patients before a visit to the healthcare facility, virtually monitoring a patient visit to the healthcare facility via a means for communication to record data and information, scheduling additional patient visits, scheduling lab tests, preparing referral documents, preparing an electronic medical record, coding the patient file, generating billing information and invoices, and patient scheduling.

11. The method of operating a healthcare facility of claim 10, wherein the patient visit is recorded with a means for communication.

12. The method of operating a healthcare facility of claim 10, wherein at least one of the staff members follows up the patient visit for one of follow-up advice, follow-up care, and additional diagnosis.

13. The method of operating a healthcare facility of claim 1, wherein the healthcare facility is a hospital.

14. The method of operating a healthcare facility of claim 13, wherein at least one of the staff members is responsible for virtually monitoring an operating room to record data and information, reserving operating rooms, scheduling lab tests, scheduling operating room personnel, preparing operation reports, preparing an electronic medical record, coding the patient file, generating billing information and invoices, and responding in the event of an operating room crisis.

15. A method of operating a healthcare facility including the steps of:
providing a service provider employing a plurality of staff members;
providing a healthcare facility;
training each of the staff members in at least one of software, hardware, terminology, and practices of the client service facility in at least one of a classroom setting, a practical setting, virtual training, and on-site training at a facility of the service provider;
training additional staff members in the software, hardware, terminology, and practices of the healthcare facility by a previously-trained one of the staff members; and
providing communication between the staff members and the healthcare facility to facilitate off-site support of the healthcare facility by the staff members.

16. The method of operating a healthcare facility of claim 15, wherein the communication between the staff members and the healthcare facility is provided from one of a facility of the service provider and a facility of a one of the staff members.

17. The method of operating a healthcare facility of claim 15, wherein the staff members and the healthcare facility communicate virtually through at least one of a telephone, a computer, an internet connection, a wireless internet connection, a network connection, a video camera, a monitor, a modem, an internet radio transmission and reception equipment a VOIP connection, and instant messaging means.

18. The method of operating a healthcare facility of claim 15, wherein the healthcare facility is a hospital and at least one of the staff members is responsible for virtually monitoring an operating room to record data and information, reserving operating rooms, scheduling lab tests, scheduling operating room personnel, preparing operation reports, preparing an electronic medical record, coding the patient file, generating billing information and invoices, and responding in the event of an operating room crisis.

19. A method of operating a client service organization including the steps of:
providing a service provider employing a plurality of staff members;
providing a service organization facility;
training the staff members in at least one of software, hardware, terminology, and practices of the client service facility in at least one of a classroom setting, a practical setting, virtual training, and on-site training at the service organization facility; and
providing communication between the staff members and the service organization facility to facilitate off-site support of the service organization facility by the staff members.

20. The method of operating a client service organization of claim 19, wherein the service organization is one of an accounting firm, a law firm, and an architecture firm.
